(19) United States
(12) Patent Application Publication
(10) Pub. No.: US 2019/0356193 A1
(43) Pub. Date: Nov. 21, 2019

(54) DECOUPLING ELEMENT FOR CONNECTING POWER ELECTRONICS TO AN ELECTRIC MACHINE

(71) Applicant: ZF Friedrichshafen AG, Friedrichshafen (DE)

(72) Inventor: Dirk Schramm, Furth (DE)

(73) Assignee: ZF Friedrichshafen AG, Friedrichshafen (DE)

(21) Appl. No.: 16/468,977

(22) PCT Filed: Nov. 27, 2017
(86) PCT No.: PCT/EP2017/080454

§ 371 Date: Jun. 12, 2019

(30) Foreign Application Priority Data
Dec. 16, 2016 (DE) 10 2016 225 291.7

(51) Int. Cl. H02K 5/22; H02K 11/33

(52) U.S. Cl. CPC H02K 5/225; H02K 2203/03; H02K 11/33

(57) ABSTRACT

A decoupling element (1) for connecting power electronics (3) to an electric machine (2) is presented, comprising at least one retainer (12) made of an insulating material, and at least one busbar (11) located on the retainer (12), which has a first region (111), a second region (112) that is substantially parallel to the first region (111) and spaced apart therefrom, and a curved third region (113) serving as a spring element, which connects the first region (111) to the second region (112), wherein the at least one busbar (11) is connected at its second region (112) to the retainer (12) via at least one retaining element (121).

The present invention relates to a decoupling element for connecting power electronics to an electric machine according to the preamble of claim 1.

In electric motors, in particular for hybrid vehicles, the electrical connections are normally connected by means of busbars, which extend axially, in the outward radial direction, through a hole in the motor into a receiving space in a connection housing. The busbars are connected there to power source cables, or phase connections by means of a further connection, which in turn provides an electrical connection to an external energy unit.

A busbar element formed by two regions connected to one another via a flexible intermediate element is known from DE 10 2014 201 191 A1, by means of which a reliable electrical connection is ensured between the motor and the power electronics, even when subject to vibrations caused by the motor. Another design that protects against damage caused by vibrations is shown, e.g., in EP 1 079 502 A1, in which vibrations are likewise absorbed by a curved intermediate element. The problem of tolerance differences in the components during assembly is also addressed in JP 2011 035 984 A2, and solved by the provision of various guide elements and plug-in possibilities.

The object of the invention, to provide an improved decoupling element for connecting a power electronics to an electric machine, can be derived from the problem specified above. This object is achieved according to the invention by the features of the independent claims. Advantageous embodiments are the subject matter of the dependent claims.

A decoupling element for connecting power electronics to an electric machine is proposed, which has at least one retainer made of an insulating material, at least one busbar located on the retainer, which has a first region, a second region that is substantially parallel to the first region, and spaced apart therefrom, and a curved third region, serving as a spring element, which connects the first region to the second region, wherein the at least one busbar is connected at its second region to the retainer via at least one retaining element.

As a result of the flexible connection of the first region to the second region of the busbar via a curved third region acting as a spring element, previously problematic environmental and application conditions, such as thermal expansion or vibrational loads that could damage the electrical connection between the electric machine and the power electronics, can be avoided. Furthermore, mechanical tolerances of the installed components due to production conditions can be compensated for.

In one embodiment, the first region and second region are substantially of equal length, and overlap one another. As a result, mainly the stable curved third section is subjected to loads, such that tolerances can be compensated for, without compromising the stability of the busbar.

In one embodiment, the at least one retaining element is located on the second region of the retainer at the transition to the third region of the busbar. The location of the retaining element in the rear region in the vicinity of the third region, which must absorb the strongest forces when loaded, improves the stability of the assembly.

In a further development, the at least one retaining element is in the form of a snap-fit. The connection by means of a snap-fit enables a simple production while still ensuring a secure connection of the busbar to the retainer.

In one embodiment, there are two retaining elements on the retainer, which connect each of the at least one busbars to the retainer at two parallel lateral edges of the second region. The use of two retaining elements has the advantage that the connection is more reliable, particularly with heavy or wide components. In particular, the use of two retaining elements prevents the busbar from slipping into a diagonal position.

In one embodiment, the second region of the busbar, at a region spaced apart from the third region, and the corresponding region on the retainer, have corresponding holes for receiving a connecting means for connecting the busbar to the electric machine. By placing the holes in the retainer and busbar in the region spaced apart from the curved region, there is more space for attaching a larger connecting element, such as a nut or compression nut, without compromising the attachment of the busbar to the retainer.

In one embodiment, the retainer has at least three busbars, which are arranged adjacently and at a spacing to one another, in the same orientation. By placing numerous busbars on a single retainer, and with the same orientation. i.e. such that the third regions are each aligned in the same direction, all of the load connections of the electric machine to the power electronics can be connected via a single decoupling element. Furthermore, production is simplified and space is saved.

In one embodiment, the retainer and each of the at least one busbars are formed integrally. As a result, production is simplified, and less expensive.

Moreover, an assembly is produced that comprises an electric machine, and power electronics connected to at least one load connection of the electric machine via the decoupling element described above, wherein the side of the retainer with the decoupling element lying opposite the side on which the busbar(s) are located, faces toward the electric machine.

Further features and advantages of the invention can be derived from the following description of exemplary embodiments of the invention based on the figures in the drawings, which show details of the invention, and from the claims. The individual features can each be implemented in and of themselves, or in numerous arbitrary combinations in a variation of the invention.

Preferred embodiments of the invention shall be explained in greater detail below based on the attached drawings. Therein:

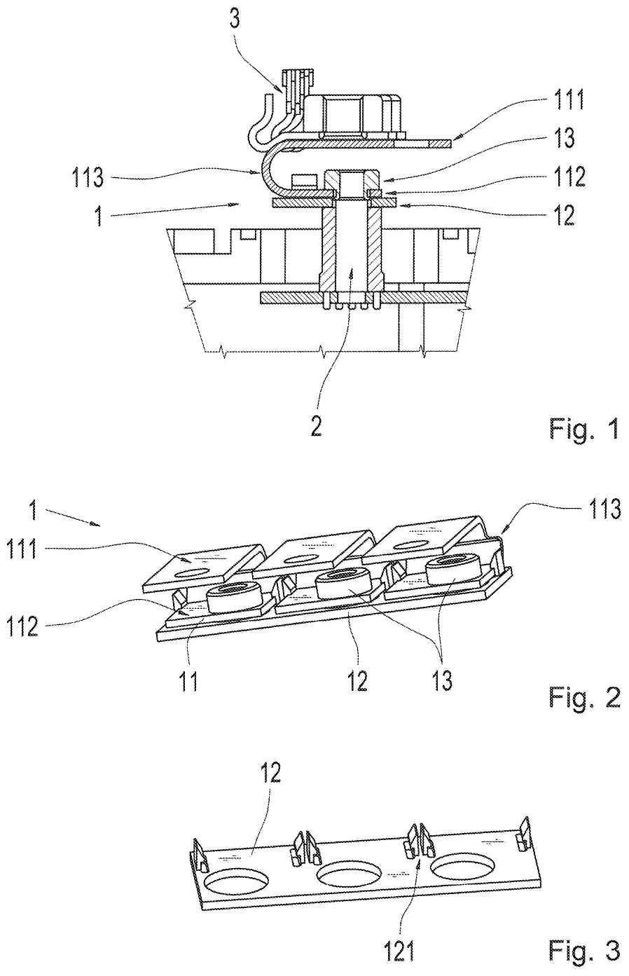

FIG. 1 shows a sectional view through a decoupling element mounted between an electric machine, or motor, and power electronics, according to an embodiment of the present invention;

FIG. 2 shows a view of a decoupling element according to an embodiment of the present invention; and

FIG. 3 shows a view of a retainer for the decoupling element according to an embodiment of the present invention.

Identical elements or functions are provided with the same reference symbols in the following description of the figures.

The invention is based on the knowledge that the electrical connection between the electric machine, or motor, and the control device, or power electronics, which are part, e.g., of a hybrid drive, can be a weak point. It can be damaged, depending on the type of connection, by the environmental and application conditions, the mechanical tolerances of the installed components, the thermal expansion over the temperature range when in use, and vibrational loads. Known solutions for connecting the electric machine, or motor, and the power electronics, comprise, e.g., rigid screw connections. These do not, however, offer a flexible compensation, such that a premature component failure may be caused by vibrations. Wire connections are also used. Although these are flexible and inexpensive, they require a large installation space. For this reason, an improved connection between the load connections of an electric machine, or motor, and the associated control device, or power electronics, is presented.

As is shown in the embodiments in FIGS. 1 to 3, the rigid connection of the electric machine 2, or motor 2, to the control device 3, or power electronics 3, is replaced with a flexible decoupling element 1, which is installed between the electric machine 2 and the power electronics 3. The embodiment shown in FIG. 1 shows a sectional view of an assembly comprising power electronics 2 connected to corresponding load connections of an electric machine 3 via the decoupling element 1 according to an embodiment of the invention, described below. FIG. 2 shows a view of the decoupling element 1 described below according to an embodiment of the invention. FIG. 3 shows the retainer 12 for the decoupling element 1 described below, according to an embodiment of the invention, to which the busbar(s) 11 are connected.

The decoupling element 1 has one or more busbars 11, which are connected to the electrically insulating retainer 12. The retainer 12 is located on the side of the electric machine 2 with the load connections after it has been installed between the electric machine 2 and the power electronics 3, as shown in FIG. 1.

Each busbar 11 can be subdivided into two regions, which are connected to one another via a third, curved or arced region. As is shown in the figures, the first region 111 is the connecting region for the power electronics 3. The second region 112 is the connecting region for the electric machine 2. The third region 113 is curved, i.e. it has a curvature, or semicircular shape, or is arced, and forms the connecting region between the first region 111 and the second region 112. The busbar 11 is preferably designed as an integral unit, such that the three regions 111, 112, 113 do not have to be connected to one another via separate connecting pieces.

The second region 112, as shown in FIG. 2, is connected with the insulating retainer 12, e.g. via a nut 13, preferably in the form of a compression nut 13, to the electric machine 2, or the corresponding connections thereon. The insulating retainer 12 has corresponding holes or cut-outs at the locations where the nut 13 is located, as does the second region 112 of the busbar(s) 11, as is shown in FIG. 2, such that a connection of the busbar 11 to the electric machine 2 via the retainer 12 can take place by means of the connecting element 13, e.g. the nut.

The retainer 12 also has at least one retaining element 121 for connecting the at least one busbar 11 thereto. The retaining element 121 can be in the form of a snap-fit, which is located on the retainer 12 such that it retains a busbar 11 via a snap-fit connection. The retaining element 121 can be located on two outer, preferably parallel sides of the second region 112 of the busbar 11, as is shown in FIGS. 2 and 3. There are thus two retaining elements 121 for each busbar 11. The retaining elements 121 are also preferably located on the region of the retainer 12 in the proximity of the third region 113 of the busbar 11, because this is where the greatest forces can act thereon. This increases the stability thereof.

A uniform spacing, or a spacing tailored to each individual busbar 11, to the adjacent busbar 11 can be established by the retaining elements 121, such that an electrical decoupling of the individual busbars 11 from one another is also ensured. Furthermore, the busbar(s) 11 are thus better prevented from slipping, particularly if the busbar(s) 11 are heavy or large. For this, the retaining elements 121 can be aligned in a row, as is shown in FIGS. 2 and 3, or they can be offset to one another. Furthermore, numerous busbars 11 are preferably arranged in the same orientation, such that their third regions 113 face in the same direction, for example, as is shown in FIG. 2.

Furthermore, by providing a retaining element 121 in the form of a snap-fit, for example, the assembly is simplified, and it is possible to release the connection. The retaining element 121 can also be a different type, as long as it satisfies the necessary requirements. The retaining elements 121 can be different for each of the busbars 11 that are to be connected, although if they are identical, they are easier and less expensive to produce.

The retainer 12 is an insulating retainer, thus made of a material that forms an electrical insulation. The retainer 12 can be an integral part, which is produced, e.g., through a casting or printing process, or some other method. It can also comprise multiple parts, wherein the individual parts can also be produced by means of appropriate methods, e.g. a casting or printing process. It is also advantageous when the retainer 12 is made of a material that also exhibits a good heat resistance. “Good,” in this case, means that the thermal resistance should be such that the material, when it is installed, will not be damaged by heat. This means that when it is installed in a motor, the heat generated by the electric machine 2, for example, will not damage the retainer 12. The necessary thermal resistance is therefore dependent on the application in which the decoupling element 1 is incorporated.

The decoupling element 1 functions fundamentally according to the principles of a curved flexible spring, which is only subject to loads in the elastic (third curved) region 113, resulting in a longer service life, among other things. Furthermore, the spring effect ensures that there is a larger tolerance range between the individual components 1, 2, 3 and at the same time, a greater stability is obtained. Moreover, vibrations can be decoupled, thus improving the vibration resistance. Furthermore, different expansions over a large temperature range can be compensated for, because of the large spring effect of the curved busbar 11. As can be seen in the figures, the first and second regions 111, 112 are basically parallel to one another and spaced apart when not in the installed or loaded state, i.e. the third curved region 113 is curved, or arced, accordingly, in order to produce the spring effect. The curvature, or bend, is preferably rounded, i.e. forming a semicircle or a U-shape, such that there are no edges or corners, which would form three sides of a rectangle or square. The shape of the curvature should be such that a flexible spring is obtained.

Furthermore, the first and second regions 111, 112 can be approximately the same length, i.e. the two regions are at a spacing to one another, lying opposite one another, and overlapping one another over a majority of their surface area. The length of the overlapping, i.e. the lengths of each of the first and second regions 111, 112 can be determined by the person skilled in the art, depending, for example, on the spring effect that is to be obtained.

The second region 112 of the busbar 11 has corresponding holes or cut-outs at the points where the busbars are connected to the retainer 12 and thus to the electric machine 2, or the load connections thereof via the connecting element 13 in the form of a nut, for example, depending on the shape of the connecting element 13, as is shown in FIG. 2. These holes correspond in terms of their positions to the holes in the retainer 12 described above.

Each busbar 11 is made of a material with a high electrical conductivity, e.g. copper Cu, or aluminum Al.

The decoupling element 1 is in a shape that is adapted to the geometry of the installation space in which it is to be installed. An embodiment is also shown in FIG. 2 in which three adjacent, or neighboring, busbars 11, with the same orientation, i.e. such that the third regions 113 are aligned, are attached to a retainer 12 by means of two snap-fits serving as retaining elements 121 on each busbar 11. These are located on the two outer parallel sides of the second region 112 of each busbar 11 at the end adjoining the curved third region 113. This means that the at least one retaining element 121 is located on a region of the retainer 12 in the vicinity of the transition from the second region 112 to the third region 113 of the busbar 11. The third regions 113 of the adjacent busbars 11 face in the same direction, toward the back surface of the retainer 12 in FIG. 3. The holes for attaching the nuts 13 for each busbar 11 are located in the second region 112 on the front surface, thus the side facing away from the curved region 113. More or fewer busbars 11 can also be placed on a single retainer 12. The decoupling element 1 can also be produced as an encased two-part component.

### REFERENCE SYMBOLS

2 electric machine or motor

3 control device or power electronics

1 decoupling element

11 busbar

111 first region of the busbar

112 second region of the busbar

113 third, curved region of the busbar

12 retainer

121 retaining element, e.g. snap-fit

13 connecting element, e.g. nut, compression nut

1-9. (canceled)

10. A decoupling element for connecting a power electronics to an electric machine, comprising:
a retainer made of an insulating material,
at least one busbar located on the retainer, which has a first region a second region, substantially parallel to and spaced apart therefrom, and a curved third region serving as a spring element, which connects the first region to the second region, wherein the at least one busbar is connected at its second region to the retainer via at least one retaining element, and wherein
the retainer and the second region are connected to the electric machine, and wherein the first region is connected to the power electronics, wherein this results in a decoupling of vibrations.

11. The decoupling element according to claim 10, wherein the first region and the second region are substantially the same length, and overlap one another.

12. The decoupling element according to claim 10, wherein the at least one retaining element is located on a region of the retainer in the vicinity of the transition from the second region of the busbar to the third region of the busbar.

13. The decoupling element according to claim 12, wherein at least one retaining element is in the form of a snap-fit.

14. The decoupling element according to claim 10, wherein two retaining elements are provided on the retainer such that they connect each of the at least one busbars at two parallel lateral edges of the second region to the retainer.

15. The decoupling element according to claim 10, wherein the second region of the busbar has holes at a region spaced apart from the third region, and at the corresponding region on the retainer, for receiving a connecting means for connecting to the electric machine.

16. The decoupling element according to claim 10, wherein the retainer has at least three one busbars, which are adjacent to one another and spaced apart from one another, in the same orientation.

17. The decoupling element according to claim 10, wherein the retainer and each of the at least one busbars are formed as integral components.

18. An assembly comprising an electric machine, and a power electronics connected to at least one load connection of the electric machine via the decoupling element according to any of the preceding claims, wherein the side of the retainer of the decoupling element that is the side on which the busbar(s) are located, is placed thereon such that it faces toward the electric machine.
